(19) United States
(12) Patent Application Publication
(10) Pub. No.: US 2010/0094709 A1
(43) Pub. Date: Apr. 15, 2010

(54) INFORMATION RECEPTION DEVICE, INFORMATION DELIVERY DEVICE, AND ADVERTISEMENT VIEWING PROGRAM

(75) Inventor: Kazuo Kuroda, Yokohama (JP)

Correspondence Address: NIXON & VANDERHYE, PC, 901 NORTH GLEBE ROAD, 11TH FLOOR, ARLINGTON, VA, 22203, US

(73) Assignee: Pioneer Corporation, Tokyo (JP)

(21) Appl. No.: 12/530,284

(22) PCT Filed: Mar. 6, 2007
(86) PCT No.: PCT/JP2007/054264

§ 371 Date: Sep. 8, 2009

(51) Int. Cl. G06Q 30/00

(52) U.S. Cl. 705/14.58

(57) ABSTRACT

An Information reception device 2 receives advertisement information d21 from an information delivery device 1 connected thereto through a communication network 3, and records the received advertisement information d21 on a storage unit 205. The information reception device 2 reproduces the advertisement information d21 recorded on the storage unit 205, upon command from the user, and, as to a reproduced advertisement, prepares information in the form of viewing history information d22 to indicate that the advertisement has been viewed, and records the information on the storage unit 205. The information reception device 2 transmits the viewing history information d22 recorded on the storage unit 205 to the information delivery device 1. In response, the information delivery device 1 calculates a user's benefit point value, based on the viewing history information d22, and transmits a sum of user's benefit point values reflected with the calculated benefit point value, to the information reception device 2.

### TECHNICAL FIELD

The present invention relates to a technique for viewing advertisement information delivered through a communication network.

### BACKGROUND ART

A viewer rating is a yardstick for indicating how many households and persons watch certain TV programs and commercials. Therefore, viewer rating data is utilized as a barometer to gauge the impact of TV as a medium and to gauge the advertising effectiveness of TV commercials, when advertisers, advertising companies and TV stations are involved in advertisement business (e.g., see Non-patent Document 1).

Non-patent Document 1: “TV RATING GUIDE BOOK”, Video Research Ltd, [on line], [retrieved on Dec. 1, 2006], Internet <URL: http://www.videor.co.jp/rating/wh/tvrating.pdf>

Patent Document 1: Japanese Patent Application Laid-Open Publication No. 2006-155738

### DISCLOSURE OF THE INVENTION

### Problems to be Solved by the Invention

However, currently used research devices are basically adapted to carry out rating research for TV programs, and not for advertisements in a strict sense. Also, commercials during TV programs correspond to the advertisements passively viewed by the users, and not the advertisements actively viewed by the users on their own free will.

The present invention has been made in light of the circumstances described above, and has an issue of providing, as an example, an information reception device, an information delivery device and an advertisement viewing program, which are able to correctly grasp those users who watch advertisements on their own free will, and are able to offer benefits to those users who watch advertisements on their own free will.

### Means for Solving the Problems

In order to achieve the issue provided above, an information reception device recited in claim 1 is characterized in that the device comprises: advertisement receiving means that receives advertisement information from an information delivery device connected thereto through a communication network; advertisement recording means that records the received advertisement information on a predetermined storage unit; advertisement reproducing means that reproduces the advertisement information recorded on the predetermined storage unit, upon command from a user; advertisement viewing history recording means that, for the reproduced advertisement, prepares information indicating that the advertisement has been viewed, in the form of advertisement viewing history information, and records the information on the predetermined storage unit; advertisement viewing history transmitting means that transmits the advertisement viewing history information recorded on the predetermined storage unit to the information delivery device; and benefit information receiving means that receives a sum of user's benefit point values from the information delivery device, the sum of user's benefit point values being reflected with the user's benefit point value that has been calculated by the information delivery device by totaling received advertisement viewing history information.

An information delivery device recited in claim 7 is able to mutually communicate with a plurality of information reception devices through a communication network, and which delivers advertisement information to the plurality of information reception devices, and characterized in that the device comprises: point storage means that stores benefit point values of users who use the plurality of information reception devices; means that transmits the advertisement information to each of the plurality of information reception devices; means that receives advertisement viewing history information from each of the plurality of information reception devices, the information indicating that the advertisements have been viewed in respect of the transmitted advertisement information; means that receives advertisement evaluation information indicative of evaluation on a viewed advertisement, from each of the plurality of information reception devices; means that receives advertisement introduction information indicative of introduction of a viewed advertisement to a different user, from each of the plurality of information reception devices; means that transmits an advertisement viewed by the user to an information reception device of the different user, according to received advertisement introduction information; point renewing means that calculates each user's benefit point value based on received advertisement viewing history information, advertisement evaluation information and advertisement introduction information, and stores a sum of the user's benefit point values reflected with the calculated benefit point value, in the point storage means; and means that transmits the sum of the user's benefit point values, which sum has been renewed by the point renewing means, to each of the plurality of information reception devices.

An advertisement viewing program recited in claim 9 is readable by a computer, and characterized in that the program permits the computer to function as advertisement receiving means that receives advertisement information from an information delivery device connected thereto through a communication network; advertisement recording means that records the received advertisement information on a predetermined storage unit; advertisement reproducing means that reproduces the advertisement information recorded on the predetermined storage unit, upon command from a user; advertisement viewing history recording means that, for the reproduced advertisement, prepares information indicating that the advertisement has been viewed in the form of advertisement viewing history information, and records the information on the predetermined storage unit; viewing history transmitting means that transmits the advertisement viewing history information recorded on the predetermined storage unit to the information delivery device; and benefit information receiving means that receives a sum of user's benefit point values from the information delivery device, the sum of user's benefit point values reflecting the user's benefit point values that have been calculated by the information delivery device by totaling the received advertisement viewing history information.

### BRIEF DESCRIPTION OF THE DRAWINGS

FIG. 1 is a schematic diagram illustrating an advertisement delivery system related to an embodiment of the present invention;

FIG. 2 is a diagram illustrating a configuration of data managed by an information delivery device of the advertisement delivery system related to the embodiment of the present invention;

FIG. 3 is a diagram illustrating a configuration of data managed by an information reception device of the advertisement delivery system related to the embodiment of the present invention;

FIG. 4 is a sequence diagram illustrating an advertisement delivery procedure performed in the advertisement delivery system related to the embodiment of the present invention;

FIG. 5 is a flow diagram illustrating an advertisement reproduction procedure performed in an information reception device 2 of the advertisement delivery system related to the embodiment of the present invention;

FIG. 6 is a sequence diagram illustrating a feedback procedure for advertisement viewing history information and advertisement evaluation information, which is performed in the advertisement delivery system related to the embodiment of the present invention;

FIG. 7 is a sequence diagram illustrating an advertisement introduction procedure performed in the advertisement delivery system related to the embodiment of the present invention;

FIG. 8 is a diagram illustrating a reproduction order of advertisements in the information reception device of the advertisement delivery system related to the embodiment of the present invention;

FIG. 9 is a diagram illustrating an example of a display screen in the information reception device of the advertisement delivery system related to the embodiment of the present invention; and

FIG. 10 is a diagram illustrating an example of a point-accrual rule for the advertisement delivery system related to the embodiment of the present invention.

### DESCRIPTION OF SYMBOLS

1: Information delivery device
2: Information reception device
3: Communication network
10: Advertisement delivery system
101: Advertisement DB
102: Advertisement delivery DB
103: User DB
104: Analysis DB
105, 201: Communication unit
106, 206: Control unit
202: Operation unit
203: Display unit
204: Voice input/output unit
205: Storage unit
d21: Advertisement information
d22: Advertisement viewing history information
d23: Advertisement evaluation information
d24: Advertisement introduction information
d25: Point-accrual information

### BEST MODE FOR EMBODYING THE PRESENT INVENTION

With reference to the drawings, hereinafter is described an embodiment of the present invention.

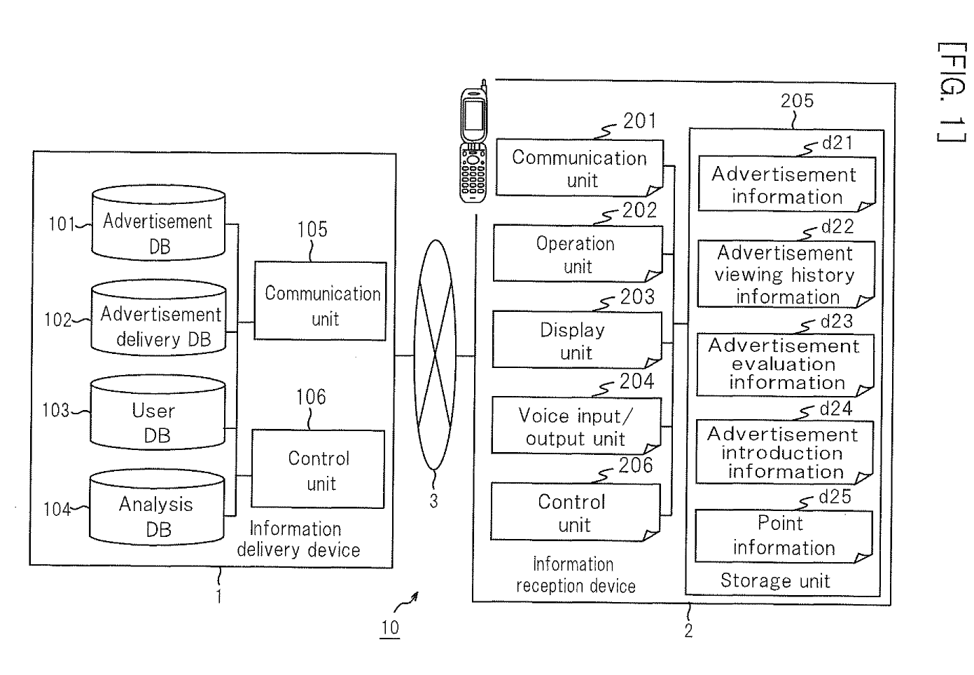

FIG. 1 is a schematic diagram illustrating an advertisement delivery system 10 related to an embodiment of the present invention. The advertisement delivery system 10 shown in FIG. 1 is a computer system including an information delivery device 1 that delivers advertisement information, an information reception device 2 that receives the advertisement information delivered by the information delivery device 1, and a communication network 3 connecting between the information delivery device 1 and the information reception device 2. This system is so configured that a user can reproduce and view the received advertisement information in the information reception device 2.

The present embodiment is described taking an advertisement delivery system as an example, with which a mobile-service provider having a mobile-phone communication infrastructure and furnished with the information delivery device 1 delivers advertisement information through the communication infrastructure. However, the present invention is not limited to this. For example, a different service provider furnished with an information delivery server may be adapted to deliver advertisement information through a different communication network. Also, the present embodiment is described taking a mobile-phone terminal as a preferred example of the information reception device 2. However, the information reception device 2 is not limited to this, but may be replaced by a mobile information terminal that can be carried by a user, or a personal computer. In the following description, the advertisement delivery system 10 will be explained as a system with which a predetermined mobile-service provider delivers advertisement information to the mobile-phone terminal of a user who has completed a contract with the predetermined mobile-service provider.

The term “advertisement” in the present embodiment refers to a moving image advertisement, for example, broadcasted with a TV commercial, or the like (in particular, an advertisement constituted of video data of static or dynamic images, and audio data). Also, the term “advertisement information” in the present embodiment refers to information that includes advertisement contents and the attributes of the advertisement.

Before proceeding to the description on the configuration and the operation of the advertisement delivery system 10 related to the present embodiment, the characteristics of the advertisement delivery system 10 will be described first.

### (1) Non-Broadcast Delivery of Advertisement

In the advertisement delivery system 10, the information delivery device 1 is adapted to deliver advertisement information to each user, which information has been randomly-selected for the user, instead of delivering identical advertisement information to all the users. The number of deliveries of one advertisement is determined using proration based on the number of total deliveries of advertisements, the number of advertisements delivered to one user, the advertisement fees paid by the individual advertisers, and the like.

(2) Viewing after Recordation of Advertisement

In the advertisement delivery system 10, the information delivery device 1 delivers advertisement information during a predetermined time zone (preferably, a time zone where the information reception device 2 is not in use, as will be described later), and the information reception device 2 records the received advertisement information within the device. After that, the user commands reproduction, on the user's free will, to view the advertisement information recorded in the information reception device 2. In this way, in the advertisement delivery system 10, the user, per se, commands reproduction operation, once the advertisements have been recorded in the information reception device 2, to view the advertisements. Therefore, the advertisements are not to be passively viewed by the user as in the conventional TV commercials, but are to be viewed by the user on the user's free will.

Further, in the advertisement delivery system 10, since the user is adapted to view the recorded advertisement information, the user can view the advertisements with clear images without interruption, even in transit, such as in a train or in an automobile. Specifically, mobile-phone terminals these days very often enable viewing of TV broadcasting (e.g. one-segment broadcasting), and thus enable viewing of commercials. However, bad reception conditions caused by obstacles or the like may disable viewing of TV broadcasting. In this regard, in the advertisement delivery system 10, advertisements can be viewed without being constrained by location and time.

### (3) Block-Unit Reproduction

In the advertisement delivery system 10, a plurality of advertisements are grouped into blocks, for reproduction by a unit of block (e.g., four advertisements may constitute one block). This is based on the assumption that, because the information reception device 2 is a mobile-phone terminal chiefly carried by the user and because the time taken for reproducing one advertisement is as short as 15 or 30 seconds or so, the user may view advertisements only for a few minutes in a spare time.

### (4) Feedback of Advertisement Viewing History Information and Advertisement Evaluation Information

In the advertisement delivery system 10, when the advertisement information recorded in the information reception device 2 has been viewed by the user, the information reception device 2 records advertisement viewing history information indicative of the fact that the user has viewed the advertisement, and at the same time transmits the advertisement viewing history information to the information delivery device 1. Therefore, the information delivery device 1 can collect the advertisement viewing history information for each user. Thus, the advertising effectiveness, such as the number of viewings of the advertisements, the viewer rating, and the attributes of the user who has viewed the advertisements, can be correctly measured. Moreover, in the advertisement delivery system 10, only those users who have willingly viewed the advertisements are counted. Therefore, measured advertising effectiveness will be a numerical value reflecting the actual condition better.

Also, in the advertisement delivery system 10, the user can give an advertisement evaluation (good, bad, or the like) on the viewed advertisements. Specifically, the information reception device 2 records advertisement evaluation information when the user has evaluated advertisements, and at the same time transmits the advertisement evaluation information to the information delivery device 1. Accordingly, the information delivery device 1 can collect information on advertisement evaluation.

### (5) Introduction of Advertisements to Friends and Acquaintances

In the advertisement delivery system 10, the user who has viewed advertisements can introduce the advertisements to other users, such as friends and acquaintances. For example, advertisements the user has become fond of after viewing, and advertisements of new products can be introduced to friends. Thus, the advertisements delivered in the advertisement delivery system 10 are not only delivered from the mobile-service provider to the user, but also transmitted from the user to other users. That is, the mobile-service provider will be furnished with a mouth-to-mouth advertising transmission path. In other words, the advertisement delivery system 10 is an advertisement delivery system in which the transmission path spreads. As a matter of course, the advertisement introduction information is also transmitted to the information delivery device 1, so that the information delivery device 1 can grasp the transmission path. In the advertisement delivery system 10, since different advertisements are delivered to each user as mentioned above, large significance may lie in the introduction of advertisements between users through word of mouth.

### (6) Offering of Benefits to Users for the Viewing of Advertisements

In the advertisement delivery system 10, beneficial points are offered to user's actions, such as advertisement viewing, advertisement evaluation and advertisement introduction as described above. These points may be points that are convertible to discount or benefits offered in specific services (e.g., communication services of the mobile-service provider), or points that function as money, securities, or the like. Thus, users, per se, are ensured to enjoy merits by viewing advertisements, in the advertisement delivery system 10.

Referring now to FIG. 1, hereinafter is described the configuration of the advertisement delivery system 10 having the characteristics described above.

The information delivery device 1 is configured, specifically, by including an advertisement database (hereinafter referred to as an advertisement DB) 101, an advertisement delivery database (hereinafter referred to as an advertisement delivery DB) 102, a user database (hereinafter referred to as a user DB) 103, an analysis database (hereinafter referred to as an analysis DB) 104, a communication unit 105 and a control unit 106.

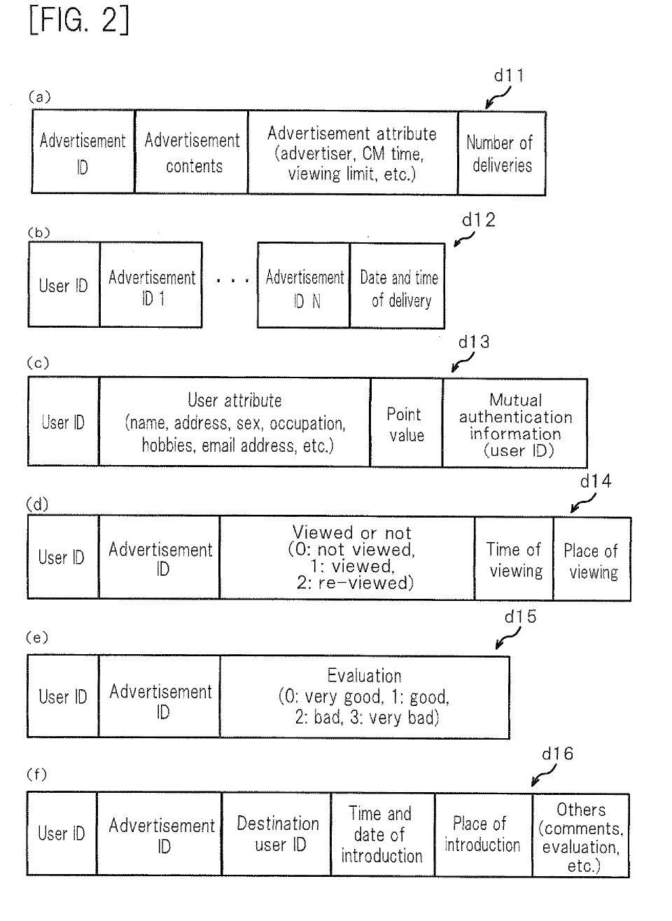

The advertisement DB 101 is a database that manages the contents of advertisement and the attribute information of advertisements and is adapted to store advertisement information d11 as shown in FIG. 2 by (a). In particular, the advertisement DB 101 manages the advertisement contents, the attribute information of advertisements and the number of deliveries of advertisements, for example, for every advertisement ID so as to univocally identify the advertisements.

The advertisement delivery DB 102 is a database that manages the advertisements to be delivered to the user and is configured to store advertisement delivery information d12 as shown in FIG. 2 by (b). In particular, the advertisement delivery DB 102 manages IDs and time and date, for example, of one or more advertisements to be delivered to the user, for every user ID so as to univocally identify the user.

The user ID 103 is a database that manages user's attribute information and is adapted to store user information d13 as shown in FIG. 2 by (c). In particular, the user DB 103 manages attribute information, point values and information on mutual authentication (information for managing the authenticated user, because, as will be described later, authentication of the person to be introduced is required in the present embodiment in introducing advertisements), for example, for every user ID.

The analysis DB 104 is a database that stores and manages the advertisement viewing history information, the advertisement evaluation information and the advertisement introduction information, for example, which are fed-back from the user, and is adapted to store such data as shown in FIG. 2 by (d) to (f). In particular, advertisement viewing history information d14 shown in FIG. 2 by (d) is provided to manage information related to viewing/non-viewing (information related to: not viewed, viewed, re-viewed, etc.), time and place of viewing the advertisements, for example, for every user ID and every advertisement ID. Advertisement evaluation information d15 shown in FIG. 2 by (e) is provided to manage evaluation (good, bad, etc.) on advertisements for every user ID and every advertisement ID. Advertisement introduction information d16 shown in FIG. 2 by (f) is provided to manage information on the user ID of a user to be introduced as well as time, date and place of introduction, for example, for every user ID and every advertisement ID.

The communication unit 105 is a means that enables transmission/reception of information to/from the information reception device 2 through the communication network 3.

The control unit 106 is configured by including a CPU and a memory. The control unit 106 performs control of the advertisement DB 101, the advertisement delivery DB 102, the user DB 103 and the analysis DB 104, and also performs data transmission, various computations and temporary storage of data, for example. With these performances, the control unit 106 is adapted to drive various processes, such as of delivering advertisements, collecting information that has been fed-back from the user, calculating the points of the user and measuring the advertising effectiveness, as will be described later.

The program that executes the various processes of the information delivery device 1 are stored in storage means, such as a memory and a hard disk. This program can be recorded on a computer-readable recording medium, such as a CD-ROM or DVD-ROM, and can be delivered through a communication network.

The information reception device 2 is configured, specifically, by including a communication unit 201, an operation unit 202, a display unit 203, a voice input/output unit 204, a storage unit 205 and a control unit 206.

The communication unit 201 includes processing means and an antenna for making communication with the communication network 3 (telephone network, packet network and Internet network). Thus, the communication unit 201 enables telephone communication, transmission/reception of electronic mail and data transmission/reception during web page inspection or the like. Further, the communication unit 201 also serves as a means that enables acquisition of position information (GPS information) of the information reception device 2.

The operation unit 202 serves as a means that enables a user to operate the mobile-phone terminal and to input information, for example. The operation unit 202 includes a numerical keypad (an array of buttons designated with numerals “0” to “9”, “*”, “#”, etc.) provided at a casing of the mobile-phone terminal, and an interface that converts depressions of the numerical keypad into electrical signals.

The display unit 203 serves as a means that visually notifies a user of information. For example, the display unit 203 includes a display screen, such as an LCD (liquid crystal display), and a display driver that permits the information to be displayed on the display screen.

The voice input/output unit 204 enables acquisition of external voice, such as the voice uttered by the user. At the same time, the voice input/output unit 204 also serves as a means that enables audible notification to the user, and is materialized in the form of a microphone, a speaker, or the like.

The storage unit 205 is configured by a memory, for example, and is adapted to store information related to advertisement delivery and advertisement viewing in the present embodiment. Specifically, the storage unit 205 stores advertisement information d21, advertisement viewing history information d22, advertisement evaluation information d23, advertisement introduction information d24 and point information d25.

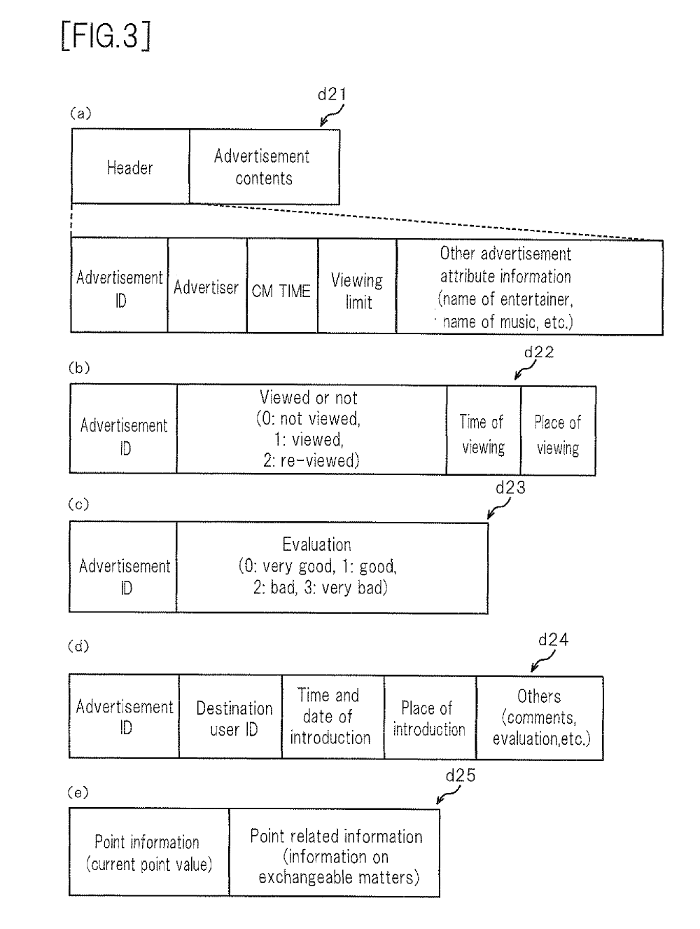

The advertisement information d21 is advertisement information that is delivered from the information delivery device 1 at predetermined times regularly or irregularly, and includes data, for example, as shown in FIG. 3 by (a). In particular, the advertisement information d21 is configured by a header and advertisement contents, the header including information on an advertisement ID, an advertiser, commercial time and a viewing limit, as well as other advertisement attribute information. As a matter of course, the advertisement information d21, if it is only configured by the advertisement contents and the advertisement attribute information (advertisement ID, advertiser, etc.), may have a data configuration different from this. For example, it may be so configured that the advertisement attribute information is embedded in the advertisement contents, using an electronic watermarking technology. In this case, unauthorized copy or data falsification can be prevented, whereby the advertisement information d21 can be delivered more securely. With the provision of the viewing limit to the advertisement information d21 in the advertisement delivery system 10, reproducing timeframe of the advertisement information d21 can be restricted.

The advertisement viewing history information d22 is the information that indicates whether or not the user has viewed the advertisement information d21 through the information delivery device 2. For example, as shown in FIG. 3 by (b), the advertisement viewing history information d22 is provided to manage information related to viewing/non-viewing (information on: not viewed, viewed, re-viewed, etc.) and the time and place of viewing the advertisement, for example, for every advertisement ID. The advertisement viewing history information d22 is transmitted, at predetermined times, from the advertisement reception apparatus 2 to the information delivery device 1.

The advertisement evaluation information d23 is evaluation information which is recorded in the case where the user has evaluated an advertisement he/she viewed through the information reception device 2. For example, as shown in FIG. 3 by (c), the advertisement evaluation information d23 is provided to manage the evaluation (very good, good, bad, vary bad, etc.) on an advertisement, for every advertisement ID. The advertisement evaluation information d23 is also transmitted, at predetermined times, from the information reception device 2 to the information delivery device 1.

The advertisement introduction information d24 is the information which is recorded in the case where the user has introduced an advertisement he/she viewed through the information reception device 2, to another user. For example, as shown in FIG. 3 by (d), the advertisement introduction information d24 is provided to manage information on the advertisement ID to be introduced, the user ID of the user to be introduced (user to whom the advertisement is to be transmitted), and other information (time, date and place of introduction, comments, evaluation, etc.). The advertisement introduction information d24 is also transmitted, at predetermined times, from the information reception device 2 to the information delivery device 1.

The point information d25 is the information related to the point acquired by the user. For example, as shown in FIG. 3 by (e), the point information d25 is configured by a current point value, point-related information including information on exchangeable matters, and the like. The point information d25 is delivered, at predetermined times regularly or irregularly, from the information delivery device 1 together with the advertisement information d21. As a matter of course, the point information d25 can be received at times other than the predetermined times upon command from the information reception device 2.

The control unit 207 is configured, for example, by a CPU and a memory and performs control of the components described above and also performs data transmission, various computations and temporary data storage, for example. With these performances, the control unit 207 is adapted to drive various processes, such as of receiving advertisements and viewing advertisements, as will be described later.

The program that executes the various processes of the information reception device 2 (hereinafter referred to as an advertisement viewing program) is stored in storage means, such as a memory. The advertisement viewing program can be recorded on a computer-readable recording medium, such as a CD-ROM or DVD-ROM, and can be delivered through a communication network.

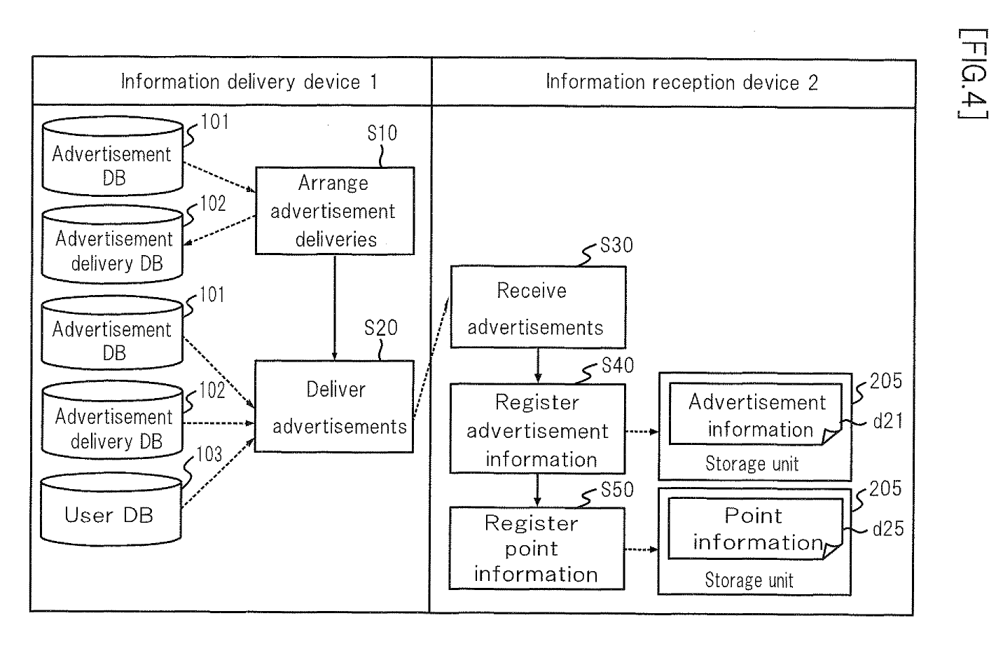

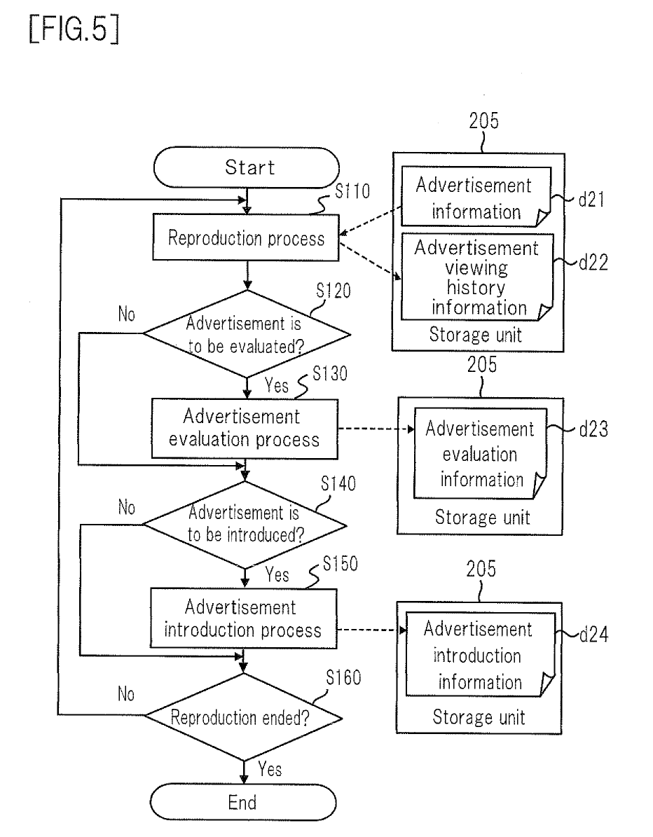

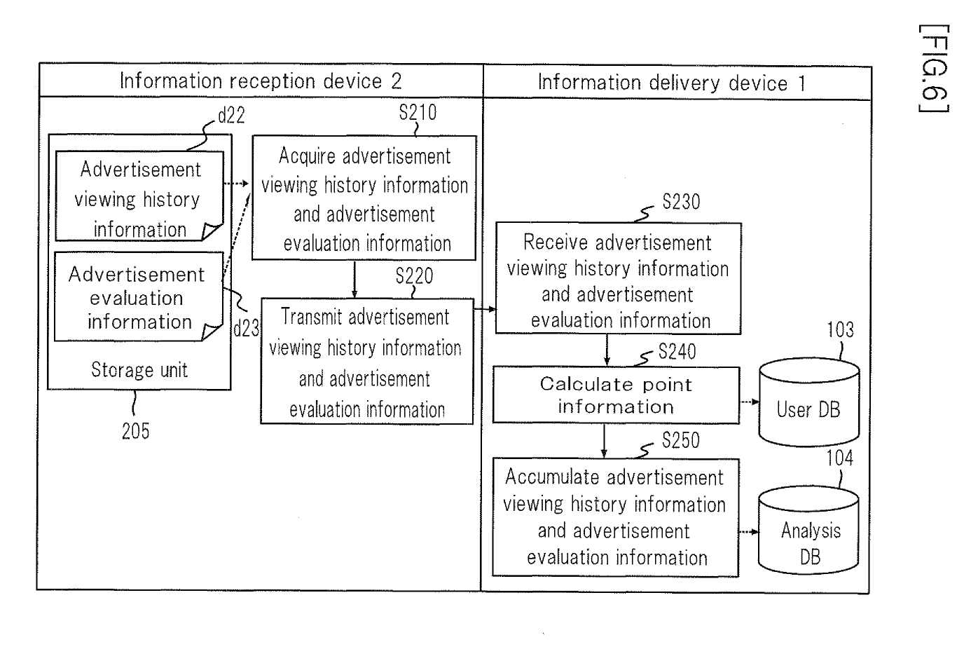

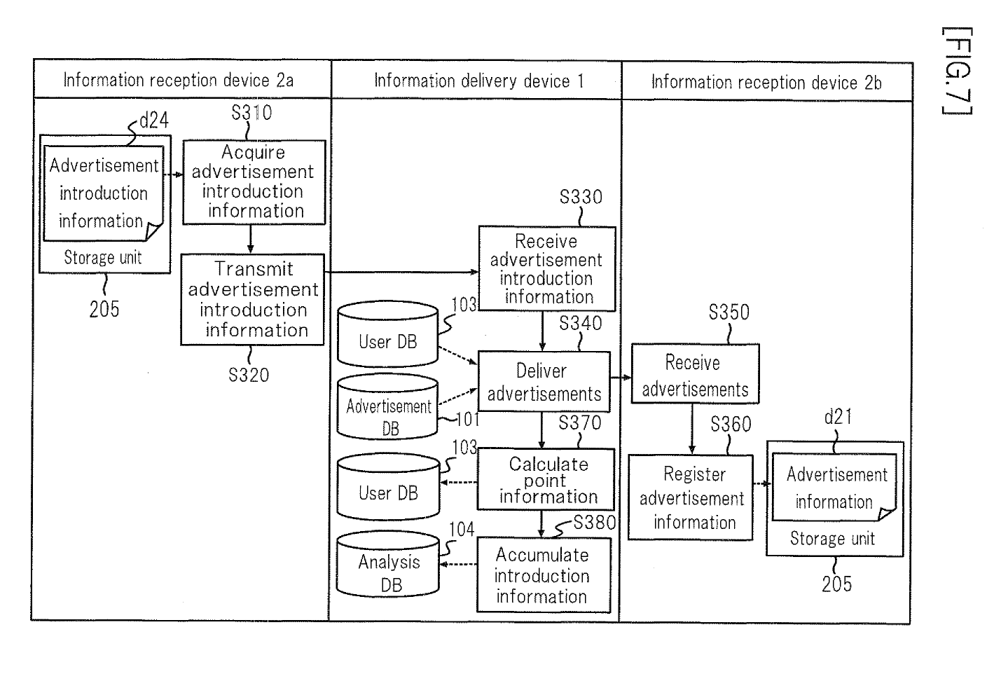

Referring now to FIGS. 4 to 7, hereinafter is described the operation of the advertisement delivery system 10. FIG. 4 is a sequence diagram illustrating an advertisement delivery procedure performed in the advertisement delivery system 10. FIG. 5 is a flow diagram illustrating an advertisement reproduction procedure performed by the information reception device 2 in the advertisement delivery system 10. FIG. 6 is a sequence diagram illustrating a feedback procedure for advertisement viewing history information and advertisement evaluation information, performed in the advertisement delivery system 10. FIG. 7 is a sequence diagram illustrating an advertisement introduction procedure performed in the advertisement delivery system 10.

First, referring to FIG. 4, the advertisement delivery procedure performed in the advertisement delivery system 10 is described.

The information delivery device 1 arranges advertisements deliveries (step S10). This is a process of determining advertisements to be delivered per user. Specifically, in this process, one or more advertisement IDs are selected at random from the advertisement information d11 to be delivered, in the advertisement DB 101. Then, the selected advertisement IDs are allocated to user IDs to prepare the advertisement delivery information d12, followed by registration in the advertisement delivery DB 102. It should be appreciated that the advertisement delivery information d12 includes delivery time and date determined for each user. For example, the delivery time and date may be the time and date instructed by the user, or may be ensured to fall in the time zone when the mobile-phone terminal is not in use, as calculated by the information reception device 2. Specifically, in the latter case, the information reception device 2 may be adapted to determine an unused time zone by performing statistical processing with respect to usage over the past one week, for example, for transmission of the information on the time zone to the information delivery device 1. Further, the advertisement delivery information d12 may not have the information related to the delivery time and date. In this case, a method may be used, in which, every time a request for transmitting the advertisement information d21 is received from the information reception device 2, the information delivery device 1 delivers the advertisement information d21. The transmission request of the advertisement information d21 from the information reception device 2 may desirably be transmitted in the time zone, as mentioned above, when the mobile-phone terminal is not in use, as calculated by the information reception device 2.

Then, the information delivery device 1 refers to the advertisement DB 101 and the advertisement delivery DB 102, and, for the user corresponding to certain delivery time and date, prepares the advertisement information d21 of the advertisements allocated to the user. Also, referring to the user DB 103, the information delivery device 1 prepares the point information d25 of the user. After that, the information delivery device 1 delivers the advertisement information d21 and the point information d25 to the information reception device 2 of each user.

Upon reception of the advertisement information d21 and the point information d25 from the information delivery device 1 (step S30), the information reception device 2 records one or more pieces of the advertisement information d21 on the storage unit 205 (step S40). Subsequently, the point information d25 is recorded on the storage unit 205. Thus, in the storage unit 205, the advertisement information d21 previously received and recorded is cleared (deleted), for the recordation of only the currently received advertisement information d21. Meanwhile, the latest user point value is reflected on the point information d25 of the storage unit 205.

Referring to FIG. 5, hereinafter is described the advertisement reproduction procedure performed by the information reception device 2 in the advertisement delivery system 10.

Upon user's command of reproduction of the recorded advertisement information d21 to the information reception device 2, the information reception device 2 acquires the advertisement information d21 recorded on the storage unit 205, blocks it and starts reproduction of the advertisement information d21 by a unit of block (step S110).

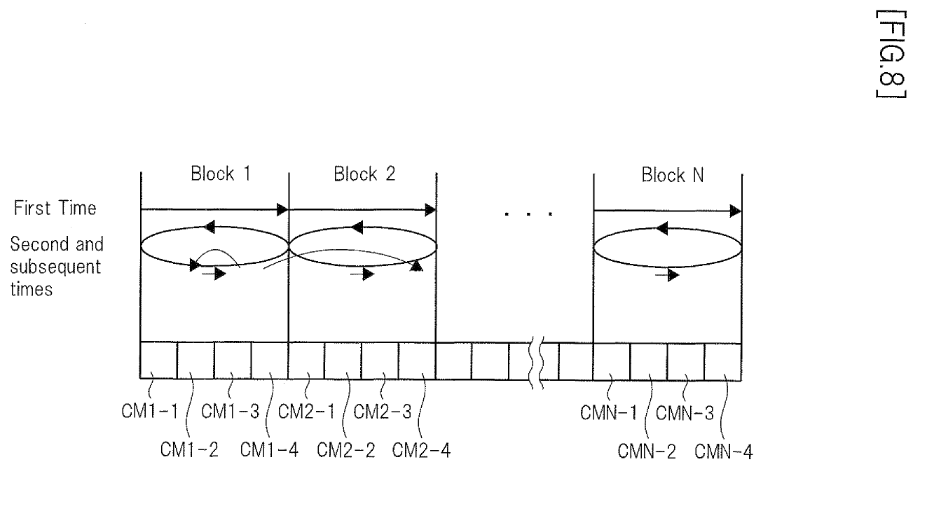

Referring now to FIG. 8, hereinafter is described a reproduction order of the advertisements in the information reception device 2. FIG. 8 shows a case where four advertisements are included in one block.

When the user commands reproduction of the advertisement information d21, a block one is selected, first, to sequentially and repeatedly reproduce the four advertisements in the block 1. In particular, advertisements CM in the block 1 are sequentially reproduced in the order of CM1-1, CM1-2, C1-3 and CM1-4. When the CM1-4 has been finished, the process comes back to the beginning to repeat the reproduction from the CM1-1. As a matter of course, the advertisements in other blocks may be reproduced, but in the first reproduction, skipping to other blocks is limited (in the second and the subsequent reproduction, skipping to other blocks or skipping to other CMs in the block is possible). In other words, when the advertisements in a given block are being viewed for the first time, operation other than “reproduction”, “stop” and “pause” is limited. This is based on the concept of the advertisement delivery system 10, which concept is to have all the advertisements viewed in a block, and then to have the advertisements in the subsequent block viewed.

However, in the advertisement delivery system 10, when it is determined that there is a high probability that the advertisements are being viewed by a single person, the advertisement information d21 is reproduced in series over blocks. In particular, in this case, after sequentially reproducing the four advertisements in the block 1, the process is adapted to proceed to a block 2, instead of coming back to the first advertisement in the block 1, to sequentially reproduce the four advertisements in the second block 2, i.e. CM2-1, CM2-2, CM2-3 and CM2-4 (similarly, when the block 2 has been finished, the process proceeds to a block 3). This is based on the judgement that, when a user solely views the advertisements, the advertisements are viewed on the user's free will, and that one reproduction can make the advertisements appealing. In the present embodiment, when the information reception device 2 determines, based on the received GPS information, that the user is on the move (does not stay at one position), during the reproduction of the advertisement information d21 by the information reception device 2, it is determined that the user is solely viewing the advertisements.

The number of advertisements configuring one block is instructed in advance by the user to the information reception device 2. For example, the number of advertisements configuring one block may be adapted to be given in terms of a parameter value, or the time of reproduction of one block may be adapted to be given in terms of a parameter value. Further, a default value of the advertisement delivery system 10 may be adapted to be used, if the parameter value is not given by the user.

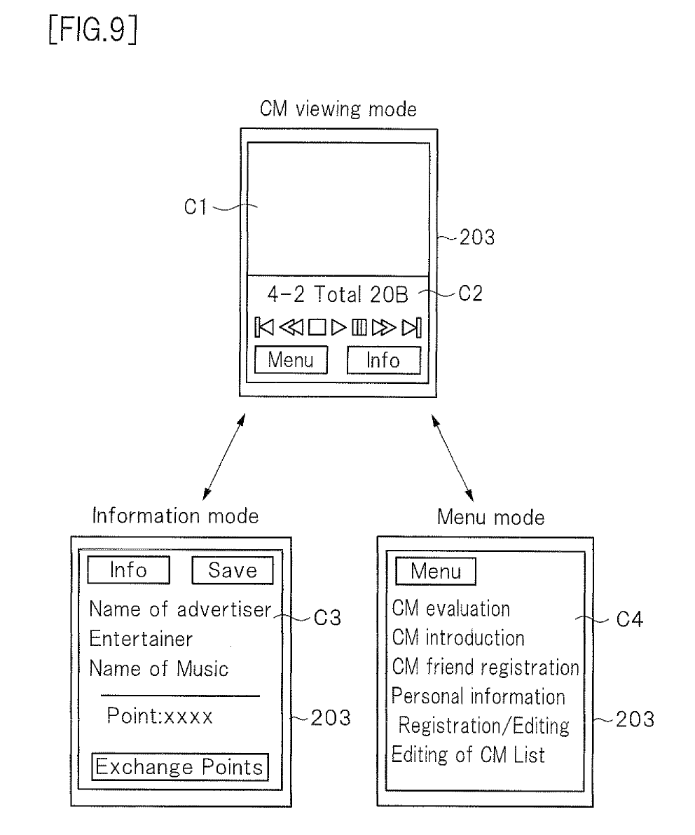

FIG. 9 shows the display unit 203 of the information reception device 2 when the advertisement information d21 is being reproduced. When reproduction of the advertisement information d21 is commanded, the advertisements are reproduced in a CM viewing mode shown in FIG. 9. In particular, upon displaying of advertisement moving image data on a CM display C1 provided at an upper part of the display unit 203, various pieces of information are displayed on an information display C2 provided at a lower part of the display unit 203. The various pieces of information include the number (the block number and the sequence number in the block) and the capacity of the advertisement currently reproduced, operation buttons (reproduction, stop, pause, fast-forward, rewind, skip to the next advertisement, and skip to the previous advertisement), and Menu buttons (Menu button and Info button) indicating change to other modes (information mode and menu mode). Operable buttons are highlighted, and the focus is changed by operating a cursor pad.

When the Info button is operated in the CM viewing mode, control is shifted to the information mode to indicate an information mode screen C3 on the display unit 203. The information mode screen C3 displays the attribute information (name of advertiser, name of entertainer, name of music, etc.) of the advertisement currently viewed and the current point value. Thus, the user can not only view the CM but also can obtain the attribute information of the advertisement, while confirming the current point value. When an “Info” button is operated in the information mode, more detailed attribute information of the advertisement concerned (e.g., more detailed product information) is transmitted from the information delivery device 1 and displayed on the display unit 203. When a “Save” button is operated in the information mode, the advertisement contents currently reproduced are separately saved, and added to a Save list. When a “POINT exchange” button is operated in the information mode, such information is displayed as what benefit is offered with the current point, and how many points are needed before the next rank benefit is enjoyed.

When the Menu button is operated in the CM viewing mode, control is shifted to the menu mode to display a menu screen C4 on the display unit 203. Processes that can be performed through the menu screen C4 include: CM evaluation (the details will be described later); CM introduction (the details will be described later); CM friend registration (In the advertisement delivery system 10, since the person to whom an advertisement can be introduced is only the user who has been registered in the system beforehand for authentication by the other party, the processes associated with the user registration and authentication are performed.); registration/editing of personal information (The user's personal data are registered and edited.); and editing of list (Saved advertisement contents are edited.).

Referring to FIG. 5 again, when the advertisement information d21 has been reproduced, the information reception device 2 prepares the advertisement viewing history information d22 (data indicating that the advertisement has been viewed or re-viewed) for the reproduced advertisement, and records the prepared data on the storage unit 205 (step S110). It should be appreciated that the term “re-viewing” is used for the case where the same advertisement has been viewed on a different occasion. Accordingly, the term “re-viewing” is not used for the case of viewing the advertisement again and again which is repeatedly reproduced within a given block. The advertisement delivery system 10 is adapted to distinctly record the fact of re-viewing as a matter of different viewing value. Further, the advertisement viewing history data d22 is also additionally recorded with viewing time and viewing place (according to the GPS information). Since the advertisement viewing history information d22 is the information as to who has viewed the advertisement, and when and where the advertisement has been viewed, advertising effectiveness can be measured in detail in the advertisement delivery system 10.

Then, the information reception device 2 determines whether or not advertisement evaluation is to be conducted of the advertisement currently viewed (step S120). This specifically is determined based on whether or not the user has operated the Menu button in the CM viewing mode shown in FIG. 9 for the shifting of control to the menu mode, and whether or not the user has selected the “CM evaluation” in the menu screen C4. In making advertisement evaluation, the information reception device 2 performs an advertisement evaluation process (step S130). In the advertisement evaluation process, the advertisement evaluation information d23 is prepared by having the user inputted the advertisement evaluation (of several stages as expressed, for example, by very good, good, bad, very bad, etc.) into the information reception device 2, for the advertisement currently viewed, and the prepared advertisement evaluation information is recorded on the storage unit 205. Thus, collecting the advertisement evaluation information d23 in addition to the advertisement viewing history information d22, advertising effectiveness can be measured in more detail in the advertisement delivery system 10.

Then, the information reception device 2 determines whether or not advertisement introduction is to be conducted of the advertisement currently viewed (step S140). This is determined, specifically, based on whether or not the user has operated the Menu button in the CM viewing mode shown in FIG. 9 for the shifting of control to the menu mode, and whether or not the user has selected the “CM introduction” in the menu screen C4. In performing the advertisement introduction, the information reception device 2 performs an advertisement introduction process (step S150). In the advertisement introduction process, the advertisement introduction information d24 is prepared by having the user inputted another user to whom the advertisement currently viewed is to be introduced, into the information reception device 2, and the prepared advertisement introduction information is recorded on the storage unit 205. The advertisement introduction information d24 is additionally recorded with such information as the advertisement ID of the advertisement to be introduced, and the user ID of the person to whom the advertisement is introduced, as well as time, date and place (according to the GPS information) of introduction, comments, and evaluation by the user, per se, who introduces the advertisement. In this way, since the advertisement introduction information d24 is the information as to who has introduced what information to whom, the transmission path of advertisements from user to user can be grasped in the advertisement delivery system 10. Further, since the advertisement information d24 also includes the information such as of time, date and place, the advertisement transmission path can be grasped in more detail, in light of such factors as age, area time and date.

In the present embodiment, the advertisement introduction information d24 is configured to have an advertisement ID but not to have advertisement contents (because this configuration can reduce the amount of data). However, the advertisement introduction information d24 is not limited to this, but may be configured to have advertisement contents.

Then, the information reception device 2 determines whether or not the reproduction of the advertisement information d21 has been ended (step S160). Specifically, this corresponds to the determination on whether or not the user has performed stop operation in the CM viewing mode shown in FIG. 9. When stop operation has been performed to end the reproduction of the advertisement information d21, the CM viewing mode is ended to end the process. On the other hand, when stop operation has not been performed, or when the reproduction of the advertisement information d21 has not been ended, control returns to step S110 to continue the reproduction process.

The advertisement evaluation process at step S130 and the advertisement introduction process at step S150 have employed a mode of evaluating and introducing the advertisement currently viewed. Alternatively, the mode may be such that an objective advertisement is selected from a list of advertisements that have been viewed up to then and that evaluation and introduction are conducted of the selected advertisement.

Referring now to FIG. 6, hereinafter is described a feedback procedure in respect of the advertisement viewing history information d22 and the advertisement evaluation information d23 performed in the advertisement delivery system 10.

The information reception device 2 acquires, at a predetermined time, the advertisement viewing history information d22 and the advertisement evaluation information d23 recorded on the storage unit 205 (step S210), and transmits the acquired advertisement viewing history information d22 and the advertisement evaluation information d23 to the information delivery device 1 (step S220).

The predetermined time may preferably be the time when the information reception device 2 receives the advertisement information d21 regularly or irregularly, but may not be limited to this time. In the present embodiment, the advertisement viewing history information d22 and the advertisement evaluation information d23 are adapted to be transmitted simultaneously. Alternatively, however, the advertisement viewing history information d22 and the advertisement evaluation information d23 may be adapted to be transmitted at different occasions.

Having transmitted the advertisement viewing history information d22 and the advertisement evaluation information d23, the information reception device 2 clears (deletes) the advertisement viewing history information d22 and the advertisement evaluation information d23 that have been recorded on the storage unit 205.

Having received the advertisement viewing history information d22 and the advertisement evaluation information d23 (step S230), the information delivery device 1 calculates point information based on the advertisement viewing history information d22 and the advertisement evaluation information d23 (step S240).

In particular, in the advertisement delivery system 10, points are adapted to be offered to the user with the user's presentation of the advertisement viewing history information d22 and the advertisement evaluation information d23. Accordingly, the information delivery device 1 calculates a point value of the user this time, based on the received advertisement viewing history information d22 and the advertisement evaluation information d23, and adds the calculated point value to the current point value to reflect the resultant value on the user DB 103.

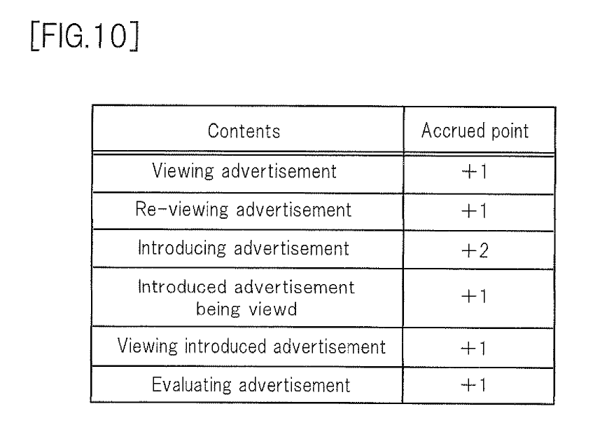

FIG. 10 shows an example of a point-accrual rule used in the advertisement delivery system 10. According to the point-accrual rule shown in FIG. 10, one point is offered when an advertisement has been viewed, further one point is given when an advertisement has been re-viewed, and one point is given when an advertisement has been evaluated.

Then, the information delivery device 1 additionally makes record of the user ID of the user to whom transmission was performed, on the received advertisement viewing history information d22 and the advertisement evaluation information d23 to prepare the advertisement viewing history information d14 and the advertisement evaluation information d15, and registers the prepared data at the analysis DB 104. Thus, the advertisement viewing history information d14 and the advertisement evaluation information d15 for each user will be accumulated in the analysis DB 104. Therefore, analyzing the data in the analysis DB 104, the advertising effectiveness can be correctly measured.

Referring now to FIG. 7, hereinafter is described the advertisement introduction procedure performed in the advertisement delivery system 10. In the following description, the information reception device of the user who introduces an advertisement is represented by 2a, and the information reception device of the user to whom the advertisement is introduced is represented by 2b.

The information reception device 2a acquires, at a predetermined time, the advertisement introduction information d24 recorded on the storage unit 205 (step S310), and transmits the acquired advertisement introduction information d24 to the information delivery device 1 (step S320).

The predetermined time may preferably be the time when the user has performed the advertisement introduction procedure in the information reception device 2a, but may be a time other than this. For example, the predetermined time may be the time when the advertisement viewing history information d22 and the advertisement evaluation information d23 are transmitted to the information delivery device 1.

Having transmitted the advertisement introduction information d24, the information reception device 2a clears (deletes) the advertisement introduction information d24 that have been recorded on the storage unit 205.

Having received the advertisement introduction information d24 (step S330), the information delivery device 1 identifies the advertisement to be introduced and the user to whom the advertisement is to be introduced. Then, the information delivery device 1 refers to the user DB 103 and the advertisement DB 101 and transmits the advertisement information d21 of the advertisement to be introduced to the information reception device 2b of the user to whom the advertisement is to be introduced (step S340). In the advertisement delivery system 10, advertisements are introduced to only those users who have been registered and authenticated. Accordingly, at step S340, it is determined that whether mutual authentication has been performed between the users, based on mutual authentication information in the user DB 103. If mutual authentication has been performed, the advertisement information d21 is transmitted to the user to whom the advertisement is to be introduced.

Having received the advertisement information d21 from the information delivery device 1 (step S350), the information reception device 2b records one or more pieces of advertisement information d21 on the storage unit 205 (step S360).

On the other hand, the information delivery device 1 calculates the point information of the user who has introduced the advertisement (sender) and the user to whom the advertisement is introduced (destination), based on the received advertisement introduction information d24 (step S370).

In the advertisement delivery system 10, when the user has introduced an advertisement, the user who has introduced the advertisement and the user to whom the advertisement has been introduced are adapted to be offered with a point. Accordingly, the information delivery device 1 calculates a point value of this time for the user, based on the received advertisement introduction information d24, and adds the calculated point value to the current point value so as to be reflected on the user DB 103.

For example, according to the point-accrual rule shown in FIG. 10, with the introduction of one advertisement, two points are offered to the sender user. When the introduced advertisement is viewed by the destination user, further one point is offered to the sender user. Also, when the destination user has viewed the introduced advertisement, one point is offered to the sender user.

Then, the information delivery device 1 adds the user ID of the user who made transmission, to the received advertisement introduction information d24 to prepare the advertisement introduction information d16, and registers the prepared data at the analysis DB 104. Thus, the advertisement introduction information d16 will be accumulated in the analysis DB 104. Therefore, analyzing the data of the analysis DB 104, the mouth-to-mouth advertising transmission path can be grasped.

In the present embodiment, since an advertisement is adapted to be received from only a person who has been authenticated, no point can be obtained even when an advertisement is transmitted to the general public. Thus, unsolicited e-mail just for intending to obtain points can be excluded.

As described above, with the advertisement delivery system 10, the information reception device 2 makes record of the advertisement information d21 delivered by the information delivery device 1, and reproduces the recorded advertisement information d21 when commanded accordingly by the user. Therefore, the advertisement information d21 can be reliably viewed by the user when the user intends to view advertisements on the user's free will. Also, with the advertisement delivery system 10, the information reception device 2 prepares the advertisement viewing history information d22 for the advertisement information d21 that has been reproduced. Therefore, those users who have intended to view advertisements with the users' free will can be correctly grasped.

In particular, the information delivery device 2 in the present embodiment is provided in the form of a mobile-phone terminal that can be always carried with the user. Therefore, the advertisement information d21 can be viewed whenever the user wishes to do so and wherever the user may be.

With the advertisement delivery system 10, the information reception device 2 repeatedly reproduces advertisements by a unit of block. Therefore, all of the advertisements in the block can be viewed by the user.

With the advertisement delivery system 10, in addition to preparing the advertisement viewing information d22, the information reception device 2 prepares the advertisement evaluation information d23 and the advertisement introduction information d24 when the user has evaluated and introduced an advertisement. Therefore, the advertising effectiveness can be measured in detail and the spread of the mouth-to-mouth transmission path can be grasped.

Regarding the introduction of an advertisement through a mouth-to-mouth communication path, such introduction of an advertisement in the present embodiment is performed between mutually authenticated users. Therefore, the users' privacy can be kept secret and thus the users can be prevented from suffering from transmission of unsolicited information.

With the advertisement delivery system 10, user's points are accrued when the user has viewed an advertisement with the user's free will, or has evaluated an advertisement the user has viewed, or has introduced the viewed advertisement to another user. Therefore, some benefits can be offered to those users who intend to willingly view advertisements. As a result, advertisement viewing can be propelled by the advertisement delivery system 10.

### Other Embodiments

The embodiment of the present invention has so far been described. However, the embodiment of the present may be variously changed or modified within a scope not departing from the spirit of the present invention.

The information reception device 2 of the above embodiment has been adapted to receive advertisements using the communication infrastructure of a mobile-service provider. In addition to this, for example, the information reception device 2 may be adapted to receive advertisements through different communication networks, such as TV broadcasting service. Specifically, advertisements in a predetermined TV broadcasting timeframe may be ensured to be received, for recordation in the device. In this way, advertisements may be adapted to be received through a plurality of communication networks for recordation, and the recorded advertisements may then be adapted to be viewed. In this case, the advertising effectiveness can be measured per communication medium that delivers advertisements. In particular, the advertisements that will be TV broadcasted can be specified utilizing the information regarding broadcasting time and date or channels, and the received information indicative of the communication medium can be added, for recordation, to the advertisement viewing history information d22. In this way, the information delivery device 1 can measure the advertising effectiveness per communication medium.

In the embodiment described above, the information delivery device 1 has been adapted to deliver the advertisement information d21 of the advertisements that have been selected at random. However, since the information delivery device 1 is provided with the user's attribute information, the information delivery device 1 may be adapted to deliver the advertisement information d21 that matches the user's preference.

1.-14. (canceled)

15. An information reception device comprising:
advertisement receiving means that receives advertisement information from an information delivery device connected thereto through a communication network;
advertisement recording means that records the received advertisement information on a predetermined storage unit;
advertisement reproducing means that reproduces the advertisement information recorded on the predetermined storage unit, upon command from a user; and
position information receiving means that receives position information of the information reception device, wherein:
the advertisement reproducing means groups the advertisement information received from the information delivery device into groups, with a predetermined number of advertisements as one group, and sequentially and repeatedly reproduces advertisements in a grouped group, and when all of the advertisements in the group have been reproduced, advertisements in a different group and specific advertisements in the group are reproducible, upon command from the user; and
the advertisement reproducing means selects either one of a reproducing method in which advertisements in a grouped group is sequentially and repeatedly reproduced, or a reproducing method in which, when all the advertisements in a group have been reproduced once, advertisements in a different group are reproduced, based on the position information of the information reception device, which position information has been received by the position information receiving means, and performs reproduction.

16. The information reception device according to claim 15, further comprising:
advertisement viewing history recording means that, for the reproduced advertisement, prepares information indicating that the advertisement has been viewed, in the form of advertisement viewing history information, and records the information on the predetermined storage unit;
advertisement viewing history transmitting means that transmits the advertisement viewing history information recorded on the predetermined storage unit to the information delivery device; and
benefit information receiving means that receives a sum of user's benefit point values from the information delivery device, the sum of user's benefit point values being reflected with the user's benefit point value that has been calculated by the information delivery device by totaling received advertisement viewing history information.

17. The information reception device according to claim 16, comprising:
advertisement evaluating means that, when the user has made an evaluation for the reproduced advertisement, prepares evaluation for the advertisement in the form of advertisement evaluation information, and records the information on the predetermined storage unit; and
advertisement evaluation transmitting means that transmits the advertisement evaluation information recorded on the predetermined storage unit to the information delivery device,
wherein the benefit information receiving means receives a sum of the user's benefit point values from the information delivery device, the sum of user's benefit point values being reflected with the user's benefit point value that has been calculated by the information delivery device by further taking into account received advertisement evaluation information.

18. The information reception device according to claim 16, further comprising:
advertisement introduction recording means that, when the user has introduced the reproduced advertisement to a different user, prepares advertisement introduction information, correlating the introduced advertisement with the different user, and records the information on the predetermined storage unit; and
advertisement introduction transmitting means that transmits the advertisement introduction information recorded on the predetermined storage unit to the information delivery device,
wherein the information delivery device transmits advertisement information of an advertisement introduced by the user, based on the received advertisement introduction information, to the information reception device of the different user; and
the benefit information receiving means receives a sum of the user's benefit point values from the information delivery device, the some of the user's benefit point values being reflected with the user's benefit point value that has been calculated by the information delivery device by further taking into account the received advertisement introduction information.

19. The information reception device according to claim 15, further comprising:
usage measuring means that measures usage of the information reception device in a predetermined timeframe,
wherein the advertisement receiving means receives the advertisement information when usage measured by the usage measuring means satisfies predetermined usage requirements.

20. An advertisement viewing program which is readable by a computer, wherein the program permits the computer to function as:
advertisement receiving means that receives advertisement information from an information delivery device connected thereto through a communication network;
advertisement recording means that records the received advertisement information on a predetermined storage unit;
advertisement reproducing means that reproduces the advertisement information recorded on the predetermined storage unit, upon command from a user;
advertisement viewing history recording means that, for the reproduced advertisement, prepares information indicating that the advertisement has been viewed, in the form of advertisement viewing history information, and records the information on the predetermined storage unit;
viewing history transmitting means that transmits the advertisement viewing history information recorded on the predetermined storage unit to the information delivery device;
benefit information receiving means that receives a sum of user's benefit point values from the information delivery device, the sum of user's benefit point values being reflected with the user's benefit point value that has been calculated by the information delivery device by totaling received advertisement viewing history information; and
position information receiving means that receives position information of the information reception device, wherein:
the advertisement reproducing means groups the advertisement information received from the information delivery device into groups, with a predetermined number of advertisements as one group, and sequentially and repeatedly reproduces advertisements in a grouped group, and when all of the advertisements in the group have been reproduced, advertisements in a different group and specific advertisements in the group are reproducible, upon command from the user; and
the advertisement reproducing means selects either one of a reproducing method in which advertisements in a grouped group is sequentially and repeatedly reproduced, or a reproducing method in which, when all the advertisements in a group have been reproduced once, advertisements in a different group are reproduced, based on the position information of the information reception device, which position information has been received by the position information receiving means, and performs reproduction.

21. The advertisement viewing program according to claim 20, wherein the program further permits the computer to function as:
advertisement evaluating means that, when the user has made an evaluation for the reproduced advertisement, prepares evaluation for the advertisement in the form of advertisement evaluation information, and records the information on the predetermined storage unit; and
advertisement evaluation transmitting means that transmits the advertisement evaluation information recorded on the predetermined storage unit to the information delivery device,
wherein the benefit information receiving means receives a sum of the user's benefit point values from the information delivery device, the sum of user's benefit point values being reflected with the user's benefit point value that has been calculated by the information delivery device by further taking into account received advertisement evaluation information.

22. The advertisement viewing program according to claim 20, wherein the program further permits the computer to function as:
advertisement introduction recording means that, when the user has introduced the reproduced advertisement to a different user, prepares advertisement introduction information, correlating the introduced advertisement with the different user, and records the information on the predetermined storage unit; and
advertisement introduction transmitting means that transmits the advertisement introduction information recorded on the predetermined storage unit to the information delivery device,
wherein the information delivery device transmits advertisement information of an advertisement introduced by the user, based on the received advertisement introduction information, to the information reception device of the different user; and
the benefit information receiving means receives a sum of the user's benefit point values from the information delivery device, the some of the user's benefit point values being reflected with the user's benefit point value that has been calculated by the information delivery device by further taking into account the received advertisement introduction information.

23. The advertisement viewing program according to claim 20, wherein the program further permits the computer to function as:
usage measuring means that measures usage of the information reception device in a predetermined timeframe,
wherein the advertisement receiving means receives the advertisement information when usage measured by the usage measuring means satisfies predetermined usage requirements.
